(19) United States
(12) Patent Application Publication
(10) Pub. No.: US 2026/0238024 A1
(43) Pub. Date: Aug. 13, 2026

(54) ELECTRONIC DEVICE AND METHOD WITH BALANCING OPERATION

(71) Applicant: Samsung Electronics Co., Ltd., Suwon-si (KR)

(72) Inventors: Jinyong JEON, Suwon-si (KR); Youngjae KIM, Suwon-si (KR)

(73) Assignee: Samsung Electronics Co., Ltd., Suwon-si (KR)

(21) Appl. No.: 19/366,136

(22) Filed: Oct. 22, 2025

(30) Foreign Application Priority Data
Feb. 13, 2025 (KR) 10-2025-0018417

(51) Int. Cl. H02J 7/00

(52) U.S. Cl. CPC H02J 7/52; H02J 7/663; H02J 7/933; H02J 2207/20

(57) ABSTRACT

An electronic device includes a plurality of batteries, first switches, wherein the first switches are connected in series respectively to the plurality of batteries, balancing circuits of the plurality of batteries, a capacitor that is connected to each of the balancing circuits and is charged by one or more of the plurality of batteries, and one or more processors configured to determine whether the plurality of batteries is in an unbalanced state based on respective state values of the plurality of batteries, control a balancing circuit of a selected battery such that the capacitor is charged by the selected battery among the plurality of batteries in response to the plurality of batteries being in the unbalanced state, determine a target battery to receive power from the capacitor among the plurality of batteries based on the respective state values of the plurality of batteries, and form a current path comprising a first switch connected in series to the target battery such that the power from the capacitor is transmitted to the target battery.

### CROSS-REFERENCE TO RELATED APPLICATIONS

This application claims the benefit under 35 USC § 119(a) of Korean Patent Application No. 10-2025-0018417, filed on Feb. 13, 2025 in the Korean Intellectual Property Office, the entire disclosure of which is incorporated herein by reference for all purposes.

### BACKGROUND

### 1. Field

The following description relates to an electronic device and method with a balancing operation.

### 2. Description of Related Art

An electronic device (e.g., an electric vehicle, a smartphone, etc.) may include a plurality of batteries. A charged state of the plurality of batteries being unbalanced may be referred to as an unbalanced state. When the plurality of batteries is in an unbalanced state, the electronic device may perform a balancing operation (e.g., active balancing) such that the batteries are in a balanced state.

A typical balancing operation may distribute power from a battery in a highly charged state equally to the remaining batteries. In addition, the typical balancing operation may not select a battery to receive power from the battery in a highly charged state. Accordingly, the typical balancing operation may incur a substantial amount of time until a plurality of batteries is in a balanced state.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one or more general aspects, an electronic device includes a plurality of batteries, first switches, wherein the first switches are connected in series respectively to the plurality of batteries, balancing circuits of the plurality of batteries, a capacitor that is connected to each of the balancing circuits and is charged by one or more of the plurality of batteries, and one or more processors configured to determine whether the plurality of batteries is in an unbalanced state based on respective state values of the plurality of batteries, control a balancing circuit of a selected battery such that the capacitor is charged by the selected battery among the plurality of batteries in response to the plurality of batteries being in the unbalanced state, determine a target battery to receive power from the capacitor among the plurality of batteries based on the respective state values of the plurality of batteries, and form a current path comprising a first switch connected in series to the target battery such that the power from the capacitor is transmitted to the target battery.

The one or more processors may be configured to form the current path by changing a state of the first switch connected in series to another battery to a turn-off state and a second switch in a balancing circuit of the other battery to a turn-on state.

The one or more processors may be configured to identify a first battery having a maximum state value among the respective state values of the plurality of batteries in response to the plurality of batteries being in the unbalanced state, and transmit a pulse width modulation (PWM) signal to a second switch of a balancing circuit of the first battery, and the balancing circuit of the first battery is configured to charge the capacitor by using the first battery in response to the PWM signal being transmitted to the second switch.

The balancing circuit of the first battery may include a transformer comprising a first coil and a second coil, may be configured to induce a current to the second coil in response to a current of the first battery flowing into the first coil while the PWM signal is transmitted to the second switch, and may be configured to charge the capacitor through the induced current.

The one or more processors may be configured to stop transmitting the PWM signal to the second switch in response to a target power of the capacitor being stored in the capacitor by using the first battery, and change a third switch connected to the capacitor to a turn-on state such that the capacitor is electrically connected to the target battery.

The one or more processors may be configured to determine the target power based on an average value of the respective state values of the plurality of batteries and a state value of the first battery, and in response to determining the target power, transmit the PWM signal to the second switch.

The one or more processors may be configured to determine the average value of the respective state values of the plurality of batteries, and determine a battery having a state value less than the average value to be the target battery.

The electronic device may include a third switch forming an electrical connection between the target battery and the capacitor, wherein the third switch is turned off before the target power is stored in the capacitor and is turned on in response to the target power being stored in the capacitor.

The one or more processors may be configured to, in response to the plurality of batteries comprising an abnormal battery that is suspected to be abnormal, change a state of a first switch connected in series to the abnormal battery to a turn-off state and a state of a second switch in a balancing circuit of the abnormal battery to a turn-on state, and in the turn-off state of the first switch connected in series to the abnormal battery and the turn-on state of the second switch in the balancing circuit of the abnormal battery, an electrical connection between the abnormal battery and another battery is stopped and an electrical connection between the balancing circuit of the abnormal battery and the other battery is formed.

In a charging mode of the electronic device, a charging current may bypass the abnormal battery and flow into the balancing circuit of the abnormal battery, and in a discharged mode of the electronic device, the abnormal battery may not not supply power to a load.

The respective state values of the plurality of batteries may include either one or both of respective voltage values and respective state of charge (SOC) values of the plurality of batteries.

In one or more general aspects, an electronic device includes a plurality of batteries, first switches, wherein the first switches are connected in series respectively to the plurality of batteries, balancing circuits of the plurality of batteries, wherein each of the balancing circuits may include a second switch, a capacitor that is connected to each of the balancing circuits and is charged by one or more of the plurality of batteries, a third switch connected to the capacitor, and one or more processors configured to determine a target battery to receive power from the capacitor among the plurality of batteries based on respective state values of the plurality of batteries in response to the plurality of batteries being in an unbalanced state, and control a first switch connected in series to the target battery, a second switch of a balancing circuit of another battery that is not the target battery, and the third switch such that the first switch connected in series to the target battery, the second switch of the balancing circuit of the other battery, and the third switch are turned on, wherein, based on a turn-on state of the first switch connected in series to the target battery, the second switch of the balancing circuit of the other battery, and the third switch, power from the capacitor is transmitted to the target battery.

In one or more general aspects, a processor-implemented method includes determining whether a plurality of batteries is in an unbalanced state based on respective state values of the plurality of batteries, charging a capacitor by controlling a balancing circuit of a selected battery in response to the plurality of batteries being in the unbalanced state, determining a target battery to receive power from the capacitor among the plurality of batteries, based on the respective state values of the plurality of batteries, and forming a current path comprising a first switch connected in series to the target battery such that the power from the capacitor is transmitted to the target battery.

The forming of the current path may include changing a state of the first switch connected in series to another battery to a turn-off state and a second switch in a balancing circuit of the other battery to a turn-on state.

The charging of the capacitor may include identifying a first battery having a maximum state value among the respective state values of the plurality of batteries in response to the plurality of batteries being in the unbalanced state, transmitting a pulse width modulation (PWM) signal to a second switch of a balancing circuit of the first battery, and charging the capacitor by using the first battery in response to the PWM signal being transmitted to the second switch.

The balancing circuit of the first battery may include a transformer comprising a first coil and a second coil, may be configured to induce a current to the second coil in response to a current of the first battery flowing into the first coil while the PWM signal is transmitted to the second switch, and may be configured to charge the capacitor through the induced current.

The method may include stopping transmitting the PWM signal to the second switch in response to a target power of the capacitor being stored in the capacitor by using the first battery, and changing a third switch connected to the capacitor to a turn-on state such that the capacitor is electrically connected to the target battery.

The method may include determining the target power based on an average value of the respective state values of the plurality of batteries and a state value of the first battery.

The determining of the target battery may include determining an average value of the respective state values of the plurality of batteries and determining a battery having a state value less than the average value to be the target battery.

The method may include, in response to the plurality of batteries comprising an abnormal battery that is suspected to be abnormal, changing a state of a first switch connected in series to the abnormal battery to a turn-off state and a state of a second switch in a balancing circuit of the abnormal battery to a turn-on state, wherein, in the turn-off state of the first switch connected in series to the abnormal battery and the turn-on state of the second switch in the balancing circuit of the abnormal battery, an electrical connection between the abnormal battery and another battery is stopped and an electrical connection between the balancing circuit of the abnormal battery and the other battery is formed.

Other features and aspects will be apparent from the following detailed description, the drawings, and the claims.

### BRIEF DESCRIPTION OF THE DRAWINGS

FIG. 1 is a block diagram illustrating an electronic device according to one or more embodiments.

FIG. 2 is a block diagram illustrating a balancing circuit of an electronic device according to one or more embodiments.

FIGS. 3A and 3B are diagrams each illustrating an example of a first switch, a balancing circuit, a capacitor, and a third switch of an electronic device according to one or more embodiments.

FIG. 4 is a diagram illustrating an example of charging batteries of an electronic device according to one or more embodiments.

FIG. 5 is a diagram illustrating an example of charging a capacitor of an electronic device according to one or more embodiments.

FIG. 6 is a diagram illustrating an example of a balancing operation of an electronic device according to one or more embodiments.

FIGS. 7 to 9 are diagrams each illustrating an example of a balancing operation of an electronic device according to one or more embodiments.

FIGS. 10 to 14 are diagrams each illustrating an example of a balancing operation of an electronic device according to one or more embodiments.

FIG. 15 is a diagram illustrating a state of each of batteries through a balancing operation of an electronic device according to one or more embodiments.

FIG. 16 is a block diagram illustrating an example of a battery system according to one or more embodiments.

FIG. 17 is a block diagram illustrating an example of a mobile device according to one or more embodiments.

FIG. 18 is a flowchart illustrating an operating method of an electronic device according to one or more embodiments.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences within and/or of operations described herein are merely examples, and are not limited to those set forth herein, but may be changed as will be apparent after an understanding of the disclosure of this application, except for sequences within and/or of operations necessarily occurring in a certain order. As another example, the sequences of and/or within operations may be performed in parallel, except for at least a portion of sequences of and/or within operations necessarily occurring in an order, e.g., a certain order. Also, descriptions of features that are known after an understanding of the disclosure of this application may be omitted for increased clarity and conciseness.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Throughout the specification, when a component or element is described as being “on”, “connected to,” “coupled to,” or “joined to” another component, element, or layer it may be directly (e.g., in contact with the other component, element, or layer) “on”, “connected to,” “coupled to,” or “joined to” the other component, element, or layer or there may reasonably be one or more other components, elements, layers intervening therebetween. When a component, element, or layer is described as being “directly on”, “directly connected to,” “directly coupled to,” or “directly joined” to another component, element, or layer there can be no other components, elements, or layers intervening therebetween. Likewise, expressions, for example, “between” and “immediately between” and “adjacent to” and “immediately adjacent to” may also be construed as described in the foregoing.

The terminology used herein is for describing various examples only and is not to be used to limit the disclosure. The articles “a,” “an,” and “the” are intended to include the plural forms as well, unless the context clearly indicates otherwise. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof, or the alternate presence of an alternative stated features, numbers, operations, members, elements, and/or combinations thereof. Additionally, while one embodiment may set forth such terms “comprise” or “comprises,” “include” or “includes,” and “have” or “has” specify the presence of stated features, numbers, operations, members, elements, and/or combinations thereof, other embodiments may exist where one or more of the stated features, numbers, operations, members, elements, and/or combinations thereof are not present.

As used herein, the term “and/or” includes any one and any combination of any two or more of the associated listed items. The phrases “at least one of A, B, and C”, “at least one of A, B, or C”, and the like are intended to have disjunctive meanings, and these phrases “at least one of A, B, and C”, “at least one of A, B, or C” (e.g., each phrase may include any one of the respective items alone, all of the items listed together, and all possible combinations thereof), and the like also include examples where there may be one or more of each of A, B, and/or C (e.g., any combination of one or more of each of A, B, and C), unless the corresponding description and embodiment necessitates such listings (e.g., “at least one of A, B, and C”) to be interpreted to have a conjunctive meaning.

Unless otherwise defined, all terms, including technical and scientific terms, used herein have the same meaning as commonly understood by one of ordinary skill in the art to which this disclosure pertains and specifically in the context on an understanding of the disclosure of the present application. Terms, such as those defined in commonly used dictionaries, are to be interpreted as having a meaning that is consistent with their meaning in the context of the relevant art and specifically in the context of the disclosure of the present application, and are not to be interpreted in an idealized or overly formal sense unless expressly so defined herein.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application. The use of the term “may” herein with respect to an example or embodiment (e.g., as to what an example or embodiment may include or implement) means that at least one example or embodiment exists where such a feature is included or implemented, while all examples are not limited thereto. The use of the terms “example”, “embodiment”, and “example embodiment” herein have a same meaning (e.g., the phrasing ‘in an or one example’ has a same meaning as ‘in an or one embodiment’ and ‘in an or one example embodiment’), and “one or more examples” has a same meaning as “one or more embodiments” and “one or more example embodiments”. Still further, each of multiple or all separately described an/one “example”, “embodiment”, “example embodiment”, as well as “examples”, “embodiments”, “example embodiments”, herein may be included, in combination, in a same embodiment in any combination.

Hereinafter, embodiments will be described in detail with reference to the accompanying drawings. When describing the examples with reference to the accompanying drawings, like reference numerals refer to like components and a repeated description related thereto will be omitted.

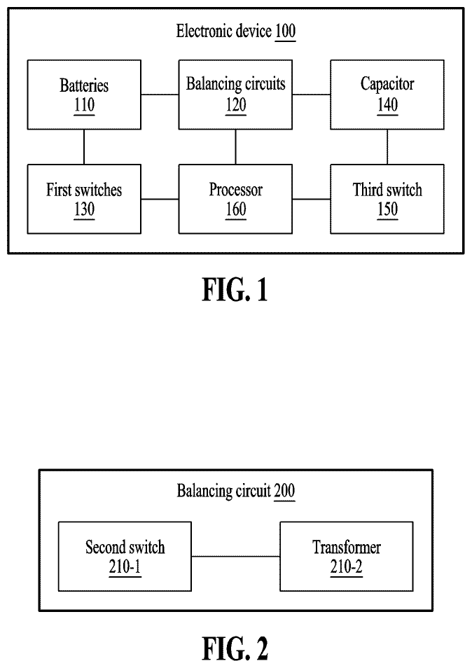

FIG. 1 is a block diagram illustrating an electronic device according to one or more embodiments.

Referring to FIG. 1, an electronic device 100, according to one or more embodiments, includes batteries 110, balancing circuits 120, first switches (and/or first switch circuits) 130, a capacitor 140, a third switch (and/or a third switch circuit) 150, and a processor 160 (e.g., one or more processors).

The electronic device 100 may correspond to, for example, an electric vehicle, a hybrid vehicle, an autonomous vehicle, an energy storage system, a robot, a drone, and/or a mobile terminal (e.g., a smartphone, a tablet personal computer (PC), etc.).

According to embodiments, each of the batteries 110 may refer to a battery cell. Without being limited thereto, each of the batteries 110 may refer to a battery module or a battery pack. The battery module may include battery cells connected in series and/or in parallel. The battery pack may include battery modules connected in series and/or in parallel.

The batteries (e.g., the battery cells, battery modules, and/or battery packs) 110 may be connected in series.

Each of the first switches 130 may be connected in series with each of the batteries 110.

Each of the balancing circuits 120 may correspond to a respective one of the batteries 110. Each of the balancing circuits 120 may perform balancing (e.g., active balancing). Each of the balancing circuits 120 may include a second switch (e.g., a second switch 210-1 of FIG. 2) and a transformer (e.g., a transformer 210-2 of FIG. 2).

The third switch 150 may be connected to the capacitor 140.

According to one or more embodiments, in a normal state of the batteries 110, the first switches 130 may be turned on, and second switches of each of the balancing circuits 120 may be turned off.

According to one or more embodiments, the batteries 110 may be in an unbalanced state. The unbalanced state may refer to a state (e.g., a voltage state or a charge state) of each of the batteries 110 being not balanced. The unbalanced state may include, for example, a state in which a difference between a maximum state value (e.g., a maximum voltage value or a maximum state of charge (SOC) value) and a minimum state value (e.g., a minimum voltage value or a minimum SOC value) among respective state values (e.g., voltage values or SOC values) of the batteries 110 are greater than or equal to a threshold value.

In an unbalanced state of the batteries 110, the processor 160 may select a battery having the maximum state value and may perform balancing (e.g., active balancing) through a balancing circuit of the selected battery. For example, the processor 160 may determine at least one target battery to receive power from the capacitor 140 among the batteries 110, based on the respective state values of the batteries 110. The processor 160 may control the balancing circuit of the selected battery to charge the capacitor 140 through the selected battery. The processor 160 may form a current path including a first switch connected in series to the at least one target battery such that power from the capacitor 140 may be transmitted to the at least one target battery. The processor 160 may control a first switch connected in series to a target battery, a second switch of a balancing circuit of another battery that is not the target battery, and the third switch 150 such that each of the first switch connected in series to the target battery, the second switch of the balancing circuit of the other battery that is not the target battery, and the third switch 150 are turned on. Accordingly, a current path may be formed through which power from the capacitor 140 is transmitted to the target battery. Based on a turn-on state of each of the first switch connected in series to the target battery, the second switch of the balancing circuit of the other battery that is not the target battery, and the third switch 150, power from the capacitor 140 may be transmitted to the target battery.

According to one or more embodiments, the processor 160, when detecting an abnormal battery among the batteries 110, may perform a bypass operation on the abnormal battery. The abnormal battery may refer to, for example, a battery (e.g., a battery whose fatigue level exceeds a certain level) that is suspected (and/or detected or determined) to be abnormal. An internal stress may include, for example, degradation of a battery. The processor 160, when detecting an abnormal battery among the batteries 110, may change a state of a first switch connected in series to the abnormal battery to be turned off (e.g. open) and may change a state of a second switch in a balancing circuit of the abnormal battery to be turned on (e.g., closed). An electrical connection between another battery (e.g., a battery other than the abnormal battery among the batteries 110) and the abnormal battery may be cut off, and current may flow to a balancing circuit of the abnormal battery rather than the abnormal battery. In a charging mode of the electronic device 100, a charging current may not flow into the abnormal battery but may flow into the balancing circuit of the abnormal battery. In a discharged mode of the electronic device 100, the abnormal battery may not supply power to a load, and a discharge current of another battery may flow into the balancing circuit of the abnormal battery.

FIG. 2 is a block diagram illustrating a balancing circuit of an electronic device according to one or more embodiments.

Referring to FIG. 2, a balancing circuit 200, according to one or more embodiments, may include the second switch 210-1 and the transformer 210-2. Each of the balancing circuits 120 in FIG. 1 may correspond to the balancing circuit 200 in FIG. 2.

The second switch 210-1 may include, for example, but is not limited to, a field effect transistor (FET).

The transformer 210-2 may include a first coil (and/or a first inductor) and a second coil (and/or a second inductor). When a current (e.g., a current of a corresponding battery of the balancing circuit 200) flows into the first coil of the transformer 210-2 while a pulse width modulation (PWM) signal is transmitted to the second switch 210-1, a current may be induced to a second coil of the transformer 210-2.

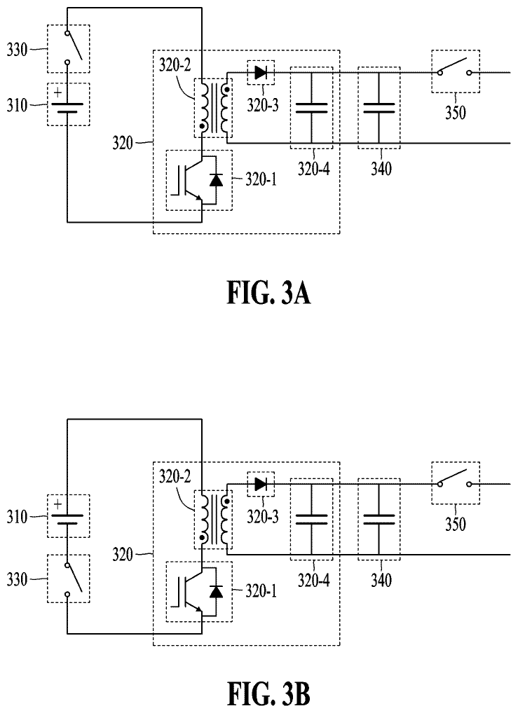

FIGS. 3A and 3B are diagrams each illustrating an example of a first switch, a balancing circuit, a capacitor, and a third switch of an electronic device according to one or more embodiments.

FIGS. 3A and 3B each illustrate a battery 310, a balancing circuit 320, a first switch 330, a capacitor 340, and a third switch 350.

The description of the balancing circuit 320 may apply to each of the balancing circuits 120 of FIG. 1. The description of the first switch 330 may apply to each of the first switches 130 of FIG. 1. The description of the capacitor 340 may apply to the capacitor 140 of FIG. 1, and the description of the third switch 350 may apply to the third switch 150 of FIG. 1.

In the example shown in FIG. 3A, the first switch 330 may be connected to a first terminal (e.g., a plus (+) terminal) of the battery 310. In the example shown in FIG. 3B, the first switch 330 may be connected to a second terminal (e.g., a minus (−) terminal) of the battery 310.

The balancing circuit 320 of FIGS. 3A and 3B may include a second switch 320-1 (e.g., the second switch 210-1 of FIG. 2), a transformer 320-2 (e.g., the transformer 210-2 of FIG. 2), a diode 320-3, and a capacitor 320-4.

The transformer 320-2 may include a first coil (and/or a first inductor) and a second coil (and/or a second inductor). In the example shown in FIG. 3A, a first terminal of the first coil of the transformer 320-2 may be connected to the first switch 330, and a second terminal of the first coil of the transformer 320-2 may be connected to the second switch 320-1. In the example shown in FIG. 3B, the second switch 320-1 may be connected to the first switch 330.

The third switch 350 may be a switch for forming an electrical connection between a target battery and the capacitor 340. The third switch 350 may be turned off before target power is stored in the capacitor 340 and may be turned on when the target power is stored in the capacitor 340.

In the examples shown in FIGS. 3A and 3B, in a normal state of the battery 310, the first switch 330 may be turned on and the second switch 320-1 may be turned off. The processor 160 may control the first switch 330 such that the first switch 330 is turned on. The processor 160 may provide or apply an on signal to the first switch 330 such that the first switch 330 is turned on. The on signal may be, for example, an electrical signal (e.g., a voltage signal) that turns on the first switch 330. When the first switch 330 is turned on and the second switch 320-1 is turned off in a charging mode of the electronic device 100, a charging current may be supplied to the battery 310. When the first switch 330 is turned on and the second switch 320-1 is turned off in a discharged state of the electronic device 100, the battery 310 may supply power to a load.

The processor 160 may identify (e.g., determine) that a state value of the battery 310 among the respective state values of the batteries 110 is a maximum state value (e.g., a maximum voltage value or a maximum SOC value). The processor 160 may determine that the batteries 110 are in an unbalanced state when a difference between the maximum state value and a minimum state value is greater than or equal to a threshold value. In an unbalanced state of the batteries 110, the balancing circuit 320 may charge the capacitor 340 by using the battery 310.

For example, the processor 160 may transmit or apply a PWM signal to the second switch 320-1. The second switch 320-1 may be repeatedly turned off and on according to the PWM signal. The PWM signal refers to, for example, a signal having a duty ratio of less than 1 (and/or less than 100%). When the PWM signal is applied to the second switch 320-1 (and/or when the second switch 320-1 is repeatedly turned off and on), a current (and/or power) may be induced from the first coil of the transformer 320-2 to the second coil of the transformer 320-2. The current (and/or power) induced to the second coil may be smoothed by the diode 320-3 and the capacitor 320-4, and power may be stored in the capacitor 340 based on the smoothed current (and/or power).

The processor 160 may determine that the battery 310 among the batteries 110 is an abnormal battery. In this case, the processor 160 may not provide an on signal to the first switch 330 such that the first switch 330 is turned off and may provide an on signal to the second switch 320-1 such that the second switch 320-1 is turned on. When the on signal is transmitted to the second switch 320-1, a current may flow into the first coil of the transformer 320-2 such that the first coil of the transformer 320-2 may be saturated, and the first coil of the transformer 320-2 may be in a short-circuit state. In the charging mode of the electronic device 100, a charging current may not be supplied to the battery 310 and may bypass the battery 310 through the balancing circuit 320. In a discharged mode of the electronic device 100, the battery 310 may not supply power to the load. Accordingly, the electronic device 100 of one or more embodiments may reduce a current burden on the battery 310, and may prevent fatigue (e.g., deterioration) of the battery 310 from increasing.

The transformer 320-2 may be in a first state in which a current (and/or power) is induced from the first coil to the second coil or a second state in which the first coil is short circuited, based on a signal transmitted to the corresponding second switch 320-1. For example, the transformer 320-2 may be in the first state when a PWM signal is transmitted to the corresponding second switch 320-1, and may be in the second state when an on signal is transmitted to the corresponding second switch 320-1. The on signal may refer to, for example, a signal having a duty ratio of 1.

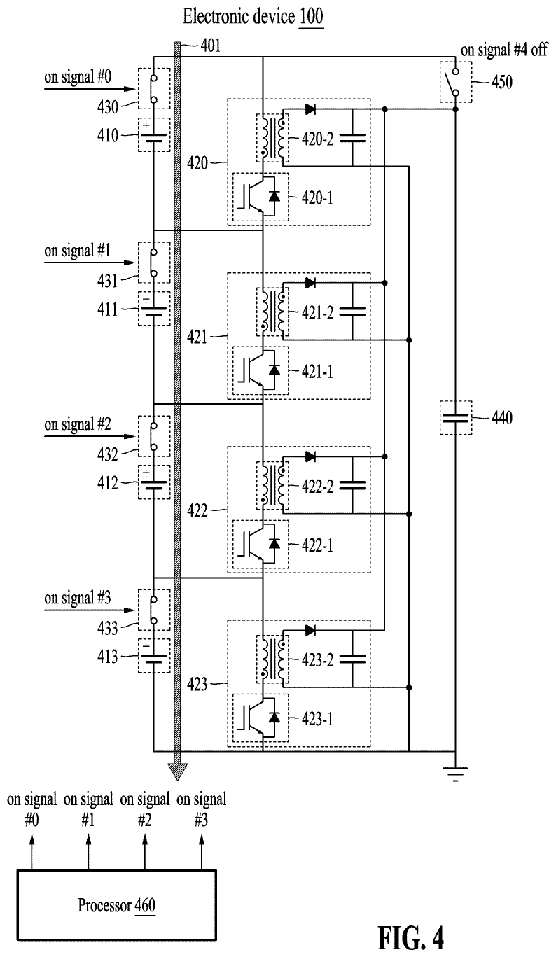

FIG. 4 is a diagram illustrating an example of charging batteries of an electronic device according to one or more embodiments.

Referring to FIG. 4, the electronic device 100 may include batteries 410, 411, 412, 413, balancing circuits 420, 421, 422, 423, first switches 430, 431, 432, 433, a capacitor 440 (e.g., the capacitor 140 of FIG. 1), a third switch 450 (e.g., the third switch 150 of FIG. 1), and a processor 460.

The batteries 410, 411, 412, 413 may be examples of the batteries 110 of FIG. 1. Each of the batteries 410, 411, 412, 413 may correspond to a battery cell, a battery module, and/or a battery pack.

The balancing circuits 420, 421, 422, 423 may be examples of the balancing circuits 120 of FIG. 1, the first switches 430, 431, 432, 433 may be examples of the first switches 130 of FIG. 1, and the processor 460 may be an example of the processor 160 of FIG. 1.

Each of the balancing circuits 420, 421, 422, 423 may correspond to the balancing circuit 320 of FIG. 3A or the balancing circuit 320 of FIG. 3B.

The balancing circuit 420 of the battery 410 may include a second switch 420-1 and a transformer 420-2. The balancing circuit 421 of the battery 411 may include a second switch 421-1 and a transformer 421-2. The balancing circuit 422 of the battery 412 may include a second switch 422-1 and a transformer 422-2. The balancing circuit 423 of the battery 413 may include a second switch 423-1 and a transformer 423-2.

The third switch 450 may refer to a switch for electrically connecting the capacitor 440 to a target battery determined among the batteries 410, 411, 412, 413. The third switch 450 may be turned off. The processor 460, when a predetermined condition is satisfied (e.g., when target power is stored in the capacitor 440 and/or when the processor 460 determines that an amount of power stored in the capacitor 440 is greater than or equal to a predetermined target power amount), may transmit an on signal to the third switch 450 such that the third switch 450 is turned on.

Although FIG. 4 illustrates four batteries 410, 411, 412, 413, four balancing circuits 420, 421, 422, 423, and four first switches 430, 431, 432, 433, this is just an example, and the number of batteries, the number of balancing circuits, and the number of first switches are not limited to the example shown in FIG. 4. The electronic device 100 may include two or more batteries/two or more balancing circuits/two or more first switches. The number of batteries, the number of balancing circuits, and the number of first switches may be the same.

The first switch 430 may be turned on by an on signal #0 of the processor 460, the first switch 431 may be turned on by an on signal #1 of the processor 460, the first switch 432 may be turned on by an on signal #2 of the processor 460, and the first switch 433 may be turned on by an on signal #3 of the processor 460.

Each of the second switch 420-1 of the balancing circuit 420, the second switch 421-1 of the balancing circuit 421, the second switch 422-1 of the balancing circuit 422, and the second switch 423-1 of the balancing circuit 423 may be turned off.

In the example shown in FIG. 4, a current path 401 may be formed. When the first switches 430, 431, 432, 433 are turned on and the second switches 420-1, 421-1, 422-1, 423-1 are turned off, the current path 401 may be formed. A charging current may flow into the batteries 410, 411, 412, 413 along the current path 401 such that the batteries 410, 411, 412, 413 are charged.

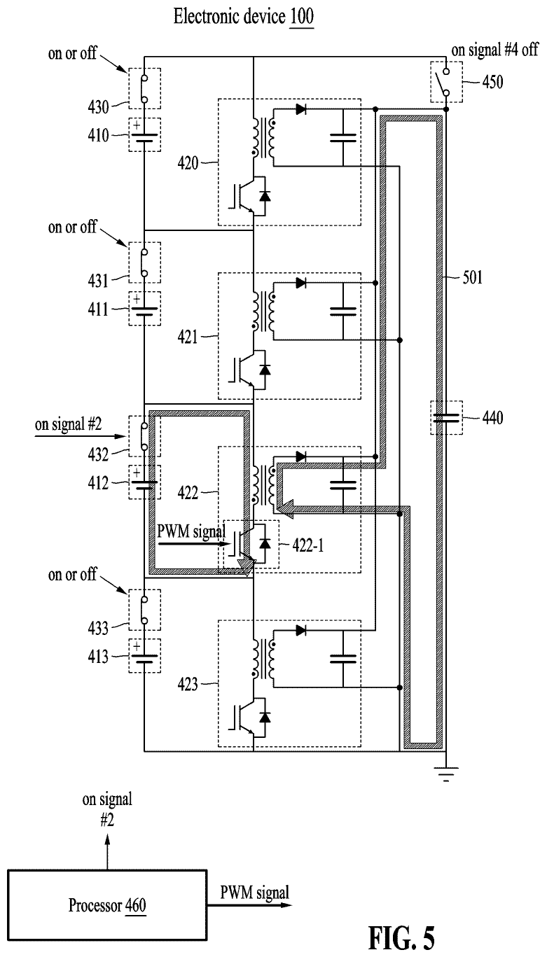

FIG. 5 is a diagram illustrating an example of charging a capacitor of an electronic device according to one or more embodiments.

Referring to FIG. 5, the first switch 432 and the third switch 450 may turned off. The first switch 430, the first switch 431, and the first switch 433 may be turned on or off.

The processor 460 may obtain respective state values (e.g., voltage values and/or SOC values) of the batteries 410, 411, 412, 413 and may select a battery to charge the capacitor 440 based on the obtained state values. For example, in the example shown in FIG. 4, among the batteries 410, 411, 412, 413, the battery 412 may have a maximum state value (e.g., a maximum voltage value and/or a maximum SOC value). The processor 460 may select the battery 412 having the maximum state value. The processor 460 may determine the battery 412 having the maximum state value as the battery to charge the capacitor 440.

The processor 460 may determine at least one target battery based on the obtained state values. The target battery may refer to a battery to receive power from the capacitor 440. The target battery may refer to a battery to be charged with power from the capacitor 440. For example, the processor 460 may determine a battery having a state value less than an average value of the obtained state values among the batteries 410, 411, 412, 413 to be the target battery. For another example, the processor 460 may determine a battery having a minimum state value among the batteries 410, 411, 412, 413 to be the target battery. For another example, the processor 460 may determine a battery having a state value less than or equal to a predetermined value to be the target battery. The number of target batteries to be determined may be one or two or more.

The processor 460 may transmit a PWM signal to the second switch 422-1 of the balancing circuit 422 of the battery 412. In this case, the other second switches 420-1, 421-1, 423-1 may be turned off.

The balancing circuit 422, when a PWM signal is transmitted to the second switch 422-1, may charge the capacitor 440 by using the battery 412. For example, when a PWM signal is transmitted to the second switch 422-1, the second switch 422-1 may be repeatedly turned off and on. When the state of the second switch 422-1 is repeatedly turned off and on according to the PWM signal, an alternating current may flow into a first coil of the transformer 422-2 of the balancing circuit 422, and a current may be induced to a second coil of the transformer 422-2. The balancing circuit 422 may charge the capacitor 440 through the current induced to the second coil of the transformer 422-2.

Based on the first switch 432 being turned on, the PWM signal being applied to the second switch 422-1, and the third switch 450 being turned off, a current path 501 of FIG. 5 may be formed, and power may be stored in the capacitor 440 according to the current path 501.

According to embodiments, the processor 460 may determine target power in the capacitor 440 based on an average value of the respective state values of the batteries 410, 411, 412, 413 and the state value of the battery 412 having the maximum state value. The target power may refer to, for example, power to be transmitted from the battery 412 to the capacitor 440 or power to charge the capacitor 440. The processor 460, when determining the target power of the capacitor 440, may transmit a PWM signal to the second switch 422-1. The processor 460 may check (e.g., determine) whether the target power of the capacitor 440 is stored in the capacitor 440 (and/or whether the target power moves from the battery 412 to the capacitor 440) through a state change (e.g., a voltage decrease or an SOC decrease) of the battery 412. The processor 460 may stop transmitting the PWM signal to the second switch 422-1 when the target power of the capacitor 440 is stored in the capacitor 440. The processor 460 may control the third switch 450 to be turned on when the target power is stored in the capacitor 440 (and/or when the processor 460 stops transmitting the PWM signal to the second switch 422-1).

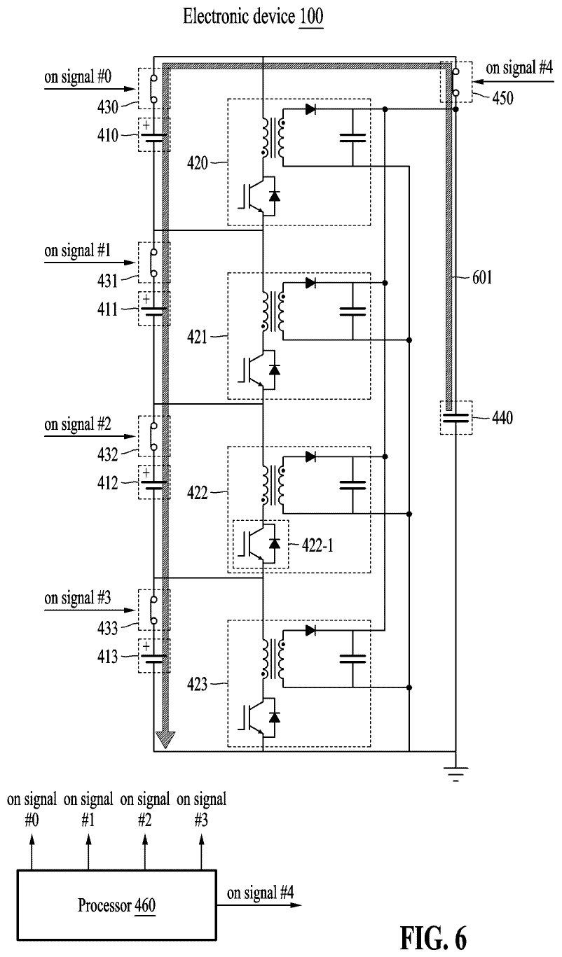

FIG. 6 is a diagram illustrating an example of a balancing operation of an electronic device according to one or more embodiments.

In the example shown in FIG. 6, the first switches 430, 431, 432, 433 may be turned on and the second switches 420-1, 421-1, 422-1, 423-1 may be turned off. The capacitor 440 may store target power and the third switch 450 may be turned on by an on signal #4 of the processor 460.

In the example shown in FIG. 6, the processor 460 may determine each of the batteries 410, 411, 412, 413 to be a target battery to receive power from the capacitor 440.

The batteries 410, 411, 412, 413 may receive power from the capacitor 440 along a current path 601.

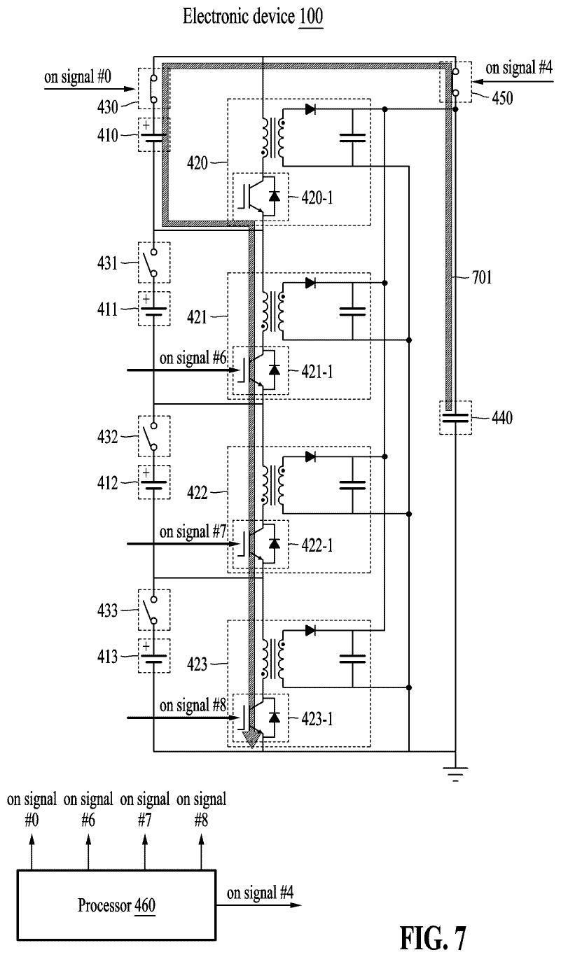

FIGS. 7 to 9 are diagrams each illustrating an example of a balancing operation of an electronic device according to one or more embodiments.

In the example shown in FIG. 7, the processor 460 may determine the battery 410 among the batteries 410, 411, 412, 413 as the target battery to receive power from the capacitor 440. Although not shown in FIG. 7, at least one of the batteries 411, 412, 413 may be used to charge the capacitor 440.

The processor 460 may form a current path 701 such that power from the capacitor 440 may be transmitted to the target battery 410 when target power is stored in the capacitor 440. For example, the processor 460 may transmit the on signal #4 to the third switch 450. The processor 460 may transmit the on signal #0 to the first switch 430 connected in series to the target battery 410. The processor 460 may transmit an on signal to a second switch in a balancing circuit of each of the batteries 411, 412, 413 that are not the target battery 410. For example, the processor 460 may transmit an on signal #6 to the second switch 421-1, may transmit an on signal #7 to the second switch 422-1, and may transmit an on signal #8 to the second switch 423-1. The first switch 430 connected in series to the target battery 410 may be turned on, a first switch connected in series to each of the batteries 411, 412, 413 that are not the target battery 410 may be turned off, the second switch 420-1 in the balancing circuit 420 of the target battery 410 may be turned off, a second switch in the balancing circuit of each of the batteries 411, 412, 413 that are not the target battery 410 may be turned on, and the third switch 450 may be turned on. Accordingly, a current path 701 may be formed.

The target battery 410 may receive power from the capacitor 440 through the current path 701.

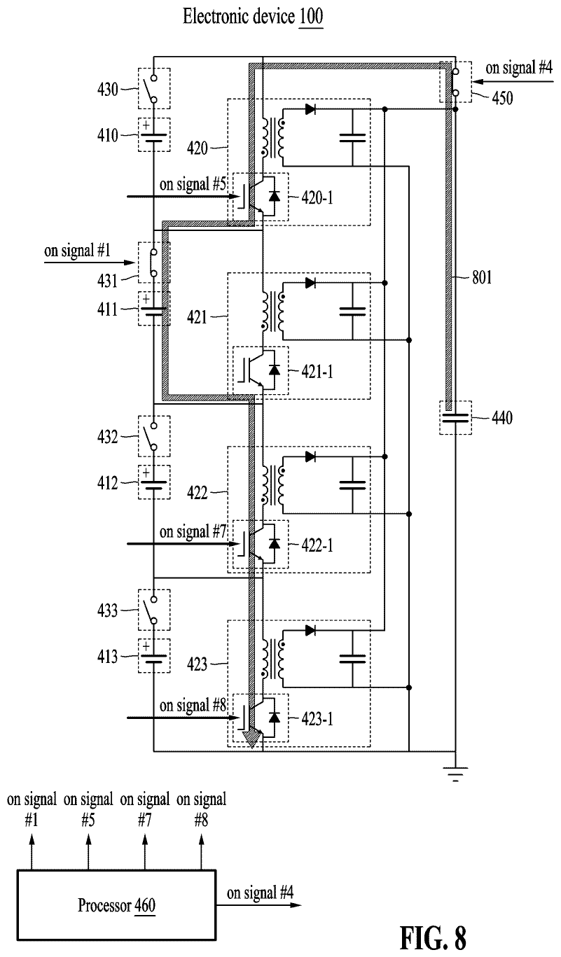

In the example shown in FIG. 8, the processor 460 may determine the battery 411 among the batteries 410, 411, 412, 413 to be a target battery to receive power from the capacitor 440. Although not shown in FIG. 8, at least one of the batteries 410, 412, 413 may be used to charge the capacitor 440.

The processor 460 may form a current path 801 such that power from the capacitor 440 may be transmitted to the target battery 411 when target power is stored in the capacitor 440. For example, the processor 460 may transmit the on signal #4 to the third switch 450. The processor 460 may transmit the on signal #1 to the first switch 431 connected in series to the target battery 411. The processor 460 may transmit an on signal to a second switch in a balancing circuit of each of the batteries 410, 412, 413 that are not the target battery 411. For example, the processor 460 may transmit an on signal #5 to the second switch 420-1, may transmit the on signal #7 to the second switch 422-1, and may transmit the on signal #8 to the second switch 423-1. The first switch 431 connected in series to the target battery 411 may be turned on, a first switch connected in series to each of the batteries 410, 412, 413 that are not the target battery 411 may be turned off, the second switch 421-1 in the balancing circuit 421 of the target battery 411 may be turned off, a second switch in the balancing circuit of each of the batteries 410, 412, 413 that are not the target battery 411 may be turned on, and the third switch 450 may be turned on. Accordingly, the current path 801 may be formed.

The target battery 411 may receive power from the capacitor 440 through the current path 801.

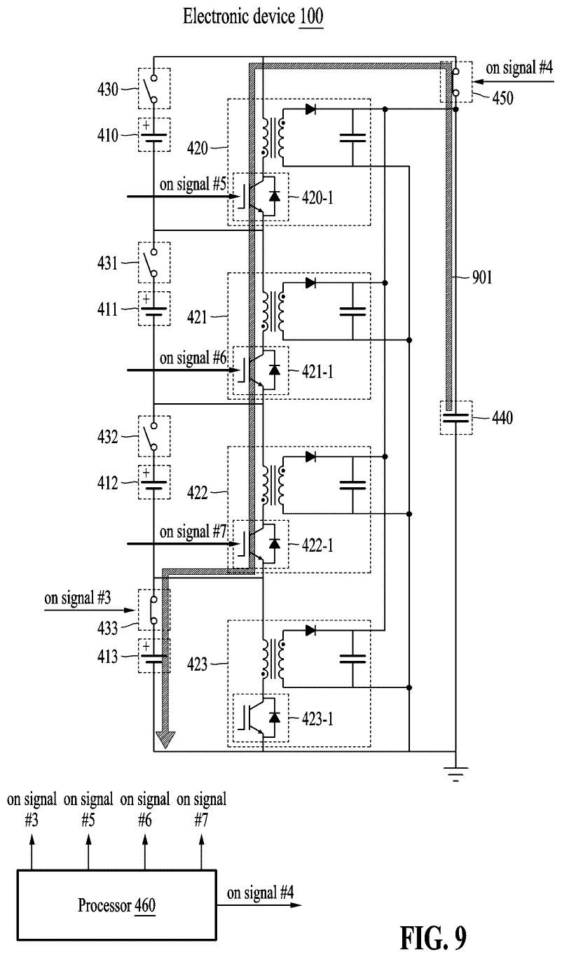

In the example shown in FIG. 9, the processor 460 may determine the battery 413 among the batteries 410, 411, 412, 413 to be a target battery to receive power from the capacitor 440. Although not shown in FIG. 9, at least one of the batteries 410, 411, 412 may be used to charge the capacitor 440.

The processor 460 may form a current path 901 such that power from the capacitor 440 may be transmitted to the target battery 413 when target power is stored in the capacitor 440. For example, the processor 460 may transmit the on signal #4 to the third switch 450. The processor 460 may transmit the on signal #3 to the first switch 433 connected in series to the target battery 413. The processor 460 may transmit an on signal to a second switch in a balancing circuit of each of the batteries 410, 411, 412 that are not the target battery 413. For example, the processor 460 may transmit an on signal #5 to the second switch 420-1, may transmit the on signal #6 to the second switch 421-1, and may transmit the on signal #7 to the second switch 422-1. The first switch 433 connected in series to the target battery 413 may be turned on, a first switch connected in series to each of the batteries 410, 411, 412 that are not the target battery 413 may be turned off, the second switch 423-1 in the balancing circuit 423 of the target battery 413 may be turned off, a second switch in the balancing circuit of each of the batteries 410, 411, 412 that are not the target battery 413 may be turned on, and the third switch 450 may be turned on. Accordingly, the current path 901 may be formed.

The target battery 413 may receive power from the capacitor 440 through the current path 901.

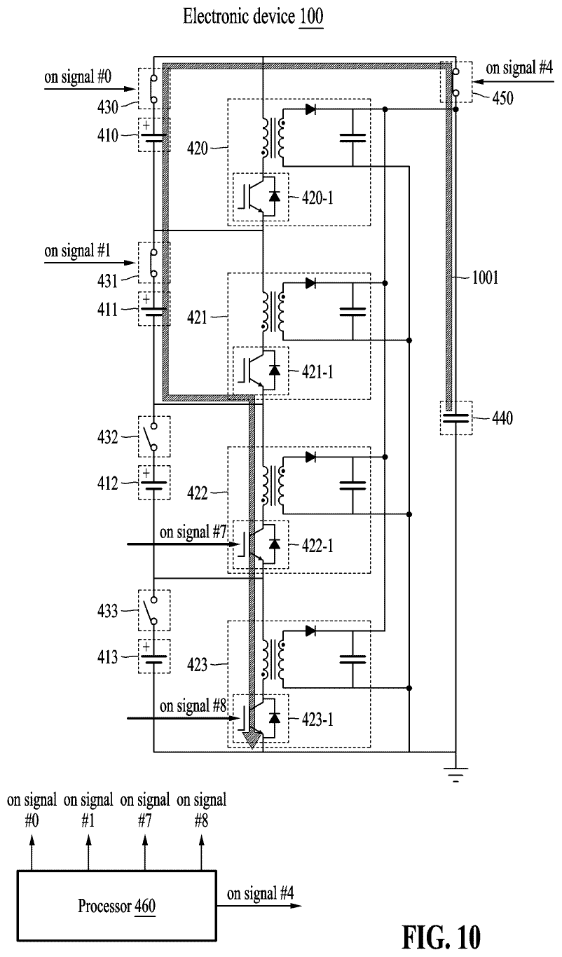

FIGS. 10 to 14 are diagrams each illustrating an example of a balancing operation of an electronic device according to one or more embodiments.

In the example shown in FIG. 10, the processor 460 may determine each of the batteries 410, 413 among the batteries 410, 411, 412, 413 to be a target battery to receive power from the capacitor 440. Although not shown in FIG. 10, at least one of the batteries 412, 413 may be used to charge the capacitor 440.

The processor 460 may form a current path 1001 such that power from the capacitor 440 may be transmitted to the target batteries 410, 411 when target power is stored in the capacitor 440. For example, the processor 460 may transmit the on signal #4 to the third switch 450. The processor 460 may transmit an on signal to respective first switches connected in series to the target batteries 410, 411. For example, the processor 460 may transmit the on signal #0 to the first switch 430 and may transmit the on signal #1 to the first switch 431. The processor 460 may transmit an on signal to a second switch in a balancing circuit of each of the batteries 412, 413 that are not the target batteries. For example, the processor 460 may transmit the on signal #7 to the second switch 422-1 and may transmit the on signal #8 to the second switch 423-1.

The respective first switches connected in series to the target batteries 410, 411 may be turned on, respective first switches connected in series to the batteries 412, 413 that are not the target batteries may be turned off, a second switch in a balancing circuit of each of the target batteries 410, 411 may be turned off, a second switch in a balancing circuit of each of the batteries 412, 413 that are not the target batteries may be turned on, and the third switch 450 may be turned on. Accordingly, the current path 1001 may be formed.

The target batteries 410, 411 may receive power from the capacitor 440 through the current path 1001.

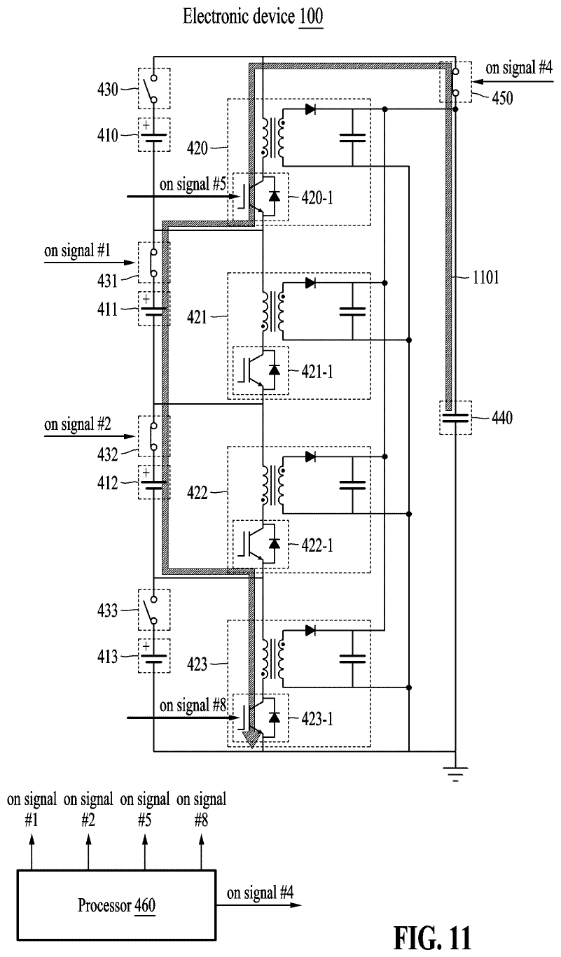

In the example shown in FIG. 11, the processor 460 may determine each of the batteries 411, 412 among the batteries 410, 411, 412, 413 to be a target battery to receive power from the capacitor 440. Although not shown in FIG. 11, at least one of the batteries 410, 413 may be used to charge the capacitor 440.

The processor 460 may form a current path 1101 such that power from the capacitor 440 may be transmitted to the target batteries 411, 412 when target power is stored in the capacitor 440. For example, the processor 460 may transmit the on signal #4 to the third switch 450. The processor 460 may transmit an on signal to respective first switches connected in series to the target batteries 411, 412. For example, the processor 460 may transmit the on signal #1 to the first switch 431 and may transmit the on signal #2 to the first switch 432. The processor 460 may transmit an on signal to a second switch in a balancing circuit of each of the batteries 410, 413 that are not the target batteries. For example, the processor 460 may transmit the on signal #5 to the second switch 420-1 and may transmit the on signal #8 to the second switch 423-1.

The respective first switches connected in series to the target batteries 411, 412 may be turned on, the respective first switches connected in series to the batteries 410, 413 that are not the target batteries may be turned off, the second switch in the balancing circuit of each of the target batteries 411, 412 may be turned off, the second switch in the balancing circuit of each of the batteries 410, 413 that are not the target batteries may be turned on, and the third switch 450 may be turned on. Accordingly, the current path 1101 may be formed.

The target batteries 411, 412 may receive power from the capacitor 440 through the current path 1101.

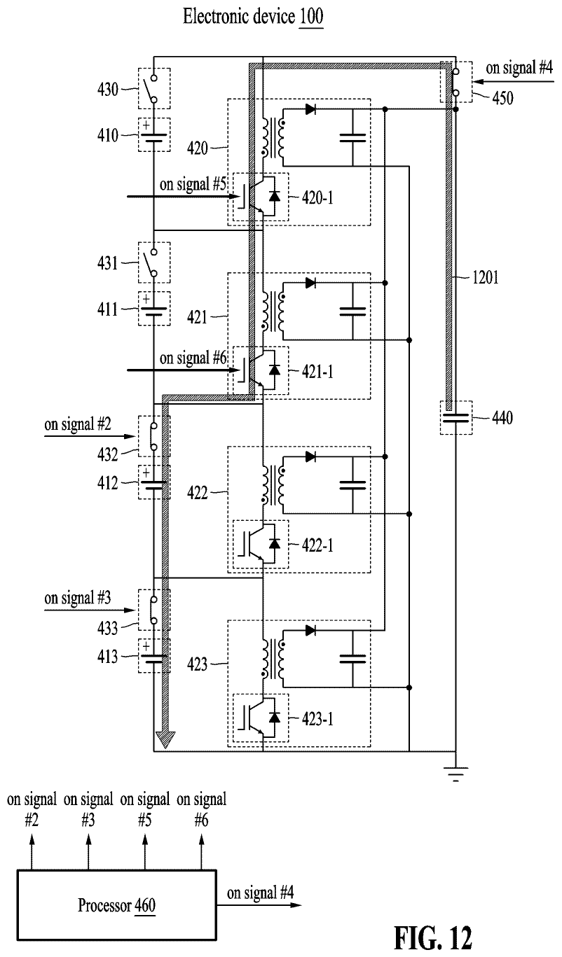

In the example shown in FIG. 12, the processor 460 may determine each of the batteries 412, 413 among the batteries 410, 411, 412, 413 to be a target battery to receive power from the capacitor 440. Although not shown in FIG. 12, at least one of the batteries 410, 411 may be used to charge the capacitor 440.

The processor 460 may form a current path 1201 such that power from the capacitor 440 may be transmitted to the target batteries 412, 413 when target power is stored in the capacitor 440. For example, the processor 460 may transmit the on signal #4 to the third switch 450. The processor 460 may transmit an on signal to respective first switches connected in series to the target batteries 412, 413. For example, the processor 460 may transmit the on signal #2 to the first switch 432 and may transmit the on signal #3 to the first switch 433. The processor 460 may transmit an on signal to a second switch in a balancing circuit of each of the batteries 410, 411 that are not the target batteries. For example, the processor 460 may transmit the on signal #5 to the second switch 420-1 and may transmit the on signal #6 to the second switch 421-1.

The respective first switches connected in series to the target batteries 412, 413 may be turned on, the respective first switches connected in series to the batteries 410, 411 that are not the target batteries may be turned off, the second switch in the balancing circuit of each of the target batteries 412, 413 may be turned off, the second switch in the balancing circuit of each of the batteries 410, 411 that are not the target batteries may be turned on, and the third switch 450 may be turned on. Accordingly, the current path 1201 may be formed.

The target batteries 412, 413 may receive power from the capacitor 440 through the current path 1201.

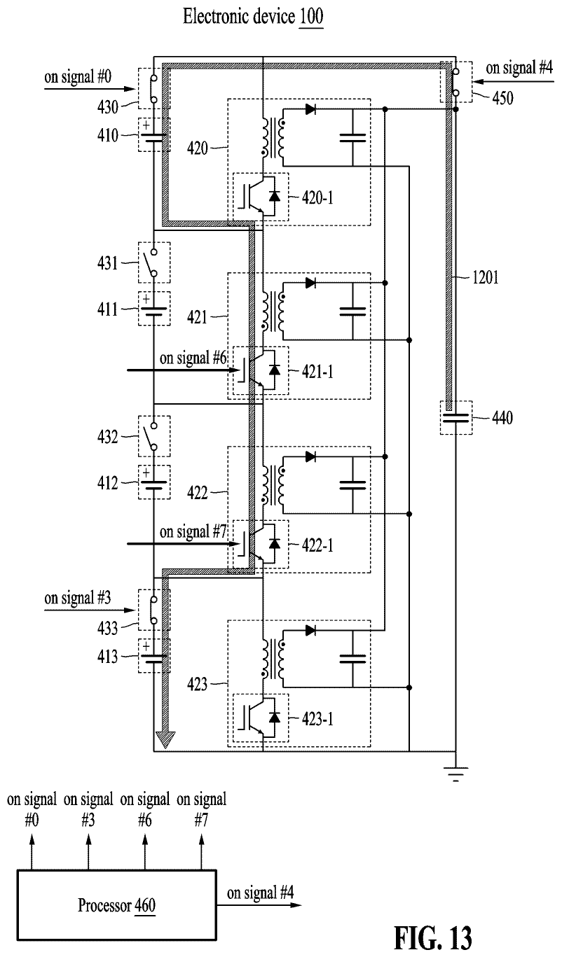

In the example shown in FIG. 13, the processor 460 may determine each of the batteries 410, 413 among the batteries 410, 411, 412, 413 to be a target battery to receive power from the capacitor 440. Although not shown in FIG. 13, at least one of the batteries 411, 412 may be used to charge the capacitor 440.

The processor 460 may form a current path 1301 such that power from the capacitor 440 may be transmitted to the target batteries 410, 413 when target power is stored in the capacitor 440. For example, the processor 460 may transmit the on signal #4 to the third switch 450. The processor 460 may transmit an on signal to respective first switches connected in series to the target batteries 410, 413. For example, the processor 460 may transmit the on signal #0 to the first switch 430 and may transmit the on signal #3 to the first switch 433. The processor 460 may transmit an on signal to a second switch in a balancing circuit of each of the batteries 411, 412 that are not the target batteries. For example, the processor 460 may transmit the on signal #6 to the second switch 421-1 and may transmit the on signal #7 to the second switch 422-1.

The respective first switches connected in series to the target batteries 410, 413 may be turned on, the respective first switches connected in series to the batteries 411, 412 that are not the target batteries may be turned off, the second switch in the balancing circuit of each of the target batteries 410, 413 may be turned off, the second switch in the balancing circuit of each of the batteries 411, 412 that are not the target batteries may be turned on, and the third switch 450 may be turned on. Accordingly, the current path 1301 may be formed.

The target batteries 410, 413 may receive power from the capacitor 440 through the current path 1301.

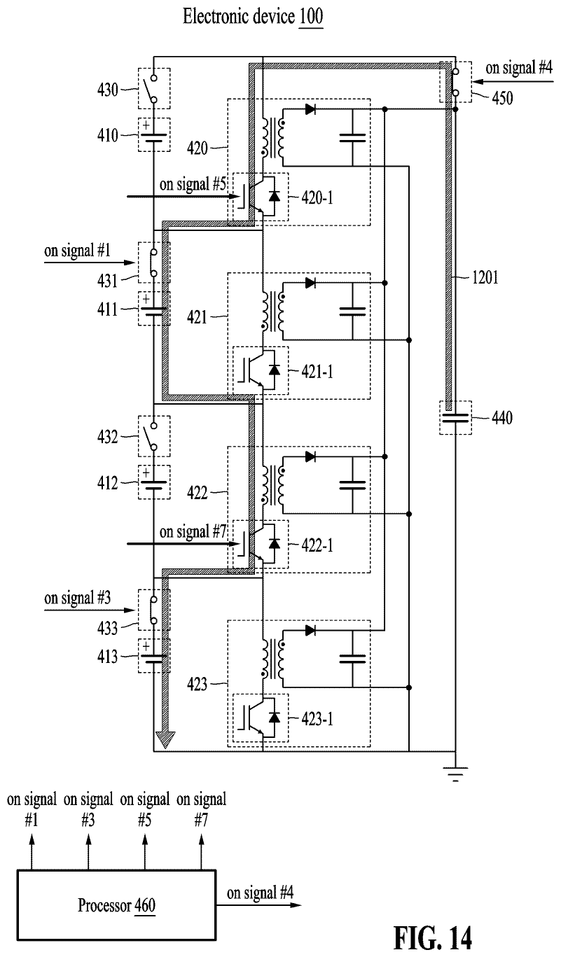

In the example shown in FIG. 14, the processor 460 may determine each of the batteries 411, 413 among the batteries 410, 411, 412, 413 to be a target battery to receive power from the capacitor 440. Although not shown in FIG. 14, at least one of the batteries 410, 412 may be used to charge the capacitor 440.

The processor 460 may form a current path 1301 such that power from the capacitor 440 may be transmitted to the target batteries 411, 413 when target power is stored in the capacitor 440. For example, the processor 460 may transmit the on signal #4 to the third switch 450. The processor 460 may transmit an on signal to respective first switches connected in series to the target batteries 411, 413. For example, the processor 460 may transmit the on signal #1 to the first switch 431 and may transmit the on signal #3 to the first switch 433. The processor 460 may transmit an on signal to a second switch in a balancing circuit of each of the batteries 410, 412 that are not the target batteries. For example, the processor 460 may transmit the on signal #5 to the second switch 420-1 and may transmit the on signal #7 to the second switch 422-1.

The respective first switches connected in series to the target batteries 411, 413 may be turned on, the respective first switches connected in series to the batteries 410, 412 that are not the target batteries may be turned off, the second switch in the balancing circuit of each of the target batteries 411, 413 may be turned off, the second switch in the balancing circuit of each of the batteries 410, 412 that are not the target batteries may be turned on, and the third switch 450 may be turned on. Accordingly, the current path 1401 may be formed.

The target batteries 411, 413 may receive power from the capacitor 440 through the current path 1401.

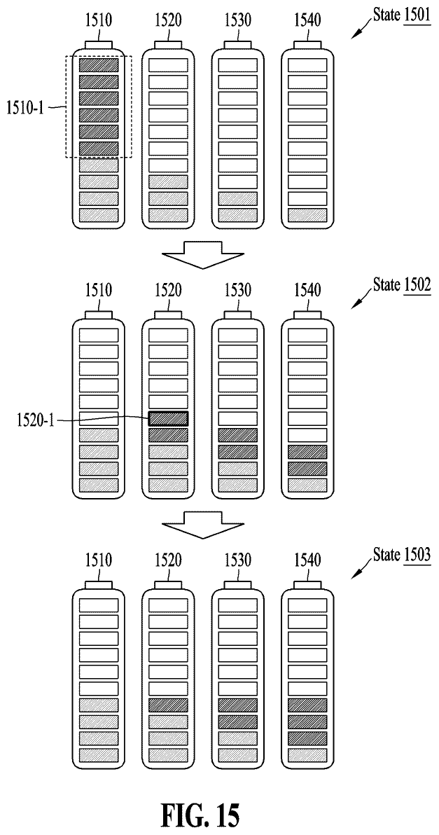

FIG. 15 is a diagram illustrating a state of each of batteries through a balancing operation of an electronic device according to one or more embodiments.

Referring to FIG. 15, the electronic device 100 may obtain a first state value of each of batteries 1510, 1520, 1530, 1540 and may determine whether the batteries 1510, 1520, 1530, 1540 are in an unbalanced state (e.g., a state 1501 of FIG. 15) based on the obtained first state values.

For example, the electronic device 100 may determine that the batteries 1510, 1520, 1530, 1540 are in an unbalanced state when a difference value between a first maximum state value (e.g., a first state value of the battery 1510) and a first minimum state value (e.g., a first state value of the battery 1540) is greater than or equal to a threshold value (e.g., a predetermined threshold value).

When the batteries 1510, 1520, 1530, 1540 are in an unbalanced state, the electronic device 100 may determine a battery having a first state value less than a first average state value (e.g., an average value of the obtained first state values) of the batteries 1510, 1520, 1530, 1540 to be a target battery. In the example shown in FIG. 15, the electronic device 100 may determine each of the batteries 1520, 1530, 1540 to be the target battery because the first state value of each of the batteries 1520, 1530, 1540 may be less than the first average state value.

The electronic device 100 may charge the capacitor 140 with the battery 1510 having the first maximum state value. According to embodiments, the electronic device 100 may determine first target power of the capacitor 140 based on the first state value of the battery 1510 and the first average state value of the batteries 1510, 1520, 1530, 1540 and may control a balancing circuit of the battery 1510 such that the determined first target power may be stored in the capacitor 140. For example, as in the example shown in FIG. 15, the electronic device 100 may determine power 1510-1 of the battery 1510 (e.g., a difference between power stored in the battery 1510 and average power of the batteries 1510, 1520, 1530, 1540) to be the first target power and may store first target power 1510-1 in the capacitor 140 through the balancing circuit of the battery 1510.

The electronic device 100 may change a state of the third switch 150 to a turn-on state when the first target power 1510-1 is stored in the capacitor 140. The electronic device 100 may determine whether the first target power 1510-1 is stored in the capacitor 140 through a state change (e.g., a voltage increase) of the capacitor 140 or a state change (e.g., a voltage decrease) of the battery 1510. The electronic device 100 may change the state of the third switch 150 to a turn-on state when determining that the first target power 1510-1 is stored in the capacitor 140.

The electronic device 100 may charge the batteries 1520, 1530, 1540 with power stored in the capacitor 140. The first target power 1510-1 may be transmitted to the batteries 1520, 1530, 1540. The electronic device 100 may change the state of the third switch 150 to a turn-off state when the first target power 1510-1 is transmitted to the batteries 1520, 1530, 1540.

A state 1502 of FIG. 15 may be a state in which the first target power 1510-1 is transmitted to the batteries 1520, 1530, 1540.

In the state 1502, the electronic device 100 may obtain a second state value of each of batteries 1510, 1520, 1530, 1540 and may determine whether the batteries 1510, 1520, 1530, 1540 are in an unbalanced state based on the obtained second state values. The electronic device 100 may determine that the batteries 1510, 1520, 1530, 1540 are in an unbalanced state when a difference value between a second maximum state value (e.g., a second state value of the battery 1520) and a second minimum state value (e.g., a second state value of the battery 1540) may be greater than or equal to the threshold value.

The electronic device 100 may determine the battery 1540 to be the target battery when the battery 1540 has a state value less than a second average state value (e.g., an average value of the obtained second state values) of the batteries 1510, 1520, 1530, 1540. The electronic device 100 may charge the capacitor 140 with the battery 1520 having the second maximum state value. According to embodiments, the electronic device 100 may determine second target power of the capacitor 140 based on the second state value of the battery 1520 and the second average state value and may control a balancing circuit of the battery 1520 such that the determined second target power may be stored in the capacitor 140. For example, as shown in the example of the state 1502 of FIG. 15, the electronic device 100 may determine power 1520-1 of the battery 1520 to be the second target power and may store the second target power 1520-1 in the capacitor 140 through a balancing circuit of the battery 1520.

The electronic device 100 may change the state of the third switch 150 to a turn-on state when the second target power 1520-1 is stored in the capacitor 140 and may charge the battery 1540 with the power stored in the capacitor 140. The second target power 1520-1 may be transmitted to the battery 1540. Accordingly, as shown in the example in a state 1503 of FIG. 15, the batteries 1510, 1520, 1530, 1540 may be in a balanced state.

According to one or more embodiments, the electronic device 100 of one or more embodiments may determine (and/or select) target battery(s) to receive power, thereby reducing balancing time.

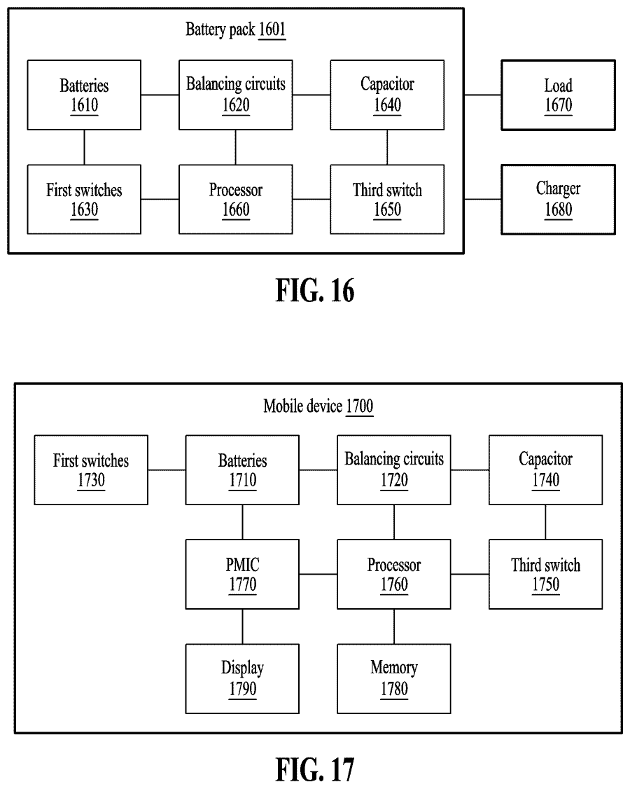

FIG. 16 is a block diagram illustrating an example of a battery system according to one or more embodiments.

Referring to FIG. 16, a battery system 1600 may include a battery pack 1601, a load 1670, and a charger 1680. The load 1670 may be, for example, a component (and/or a device) (e.g., a motor, an inverter, etc.) using batteries (e.g., battery cells or battery modules) 1610 in the battery pack 1601 as a power source. The charger 1680 may include, but is not limited to, an on board charger. According to embodiments, the load 1670 and/or the charger 1680 may be omitted from the battery system 1600.

The battery system 1600 may be applied to various devices, such as electric vehicles, hybrid vehicles, autonomous vehicles, energy storage systems, mobile robots, drones, and mobile devices (e.g., smartphones, tablet PCs, etc.).

The battery pack 1601 may include the batteries 1610, balancing circuits 1620, first switches 1630, a capacitor 1640, a third switch 1650, and a processor 1660. According to embodiments, the balancing circuits 1620, the first switches 1630, the capacitor 1640, the third switch 1650, and the processor 1660 may be implemented as a battery management device (and/or a battery control device).

The respective descriptions of the balancing circuits 420, 421, 422, 423, the first switches 430, 431, 432, 433, the capacitor 440, the third switch 450, and the processor 460 may respectively apply to the balancing circuits 1620, the first switches 1630, the capacitor 1640, the third switch 1650, and the processor 1660.

The charger 1680 may receive power from an external power source (e.g., a wired power source or a wirelessly connected power source) and may charge the batteries 1610 based on the received power.

The processor 1660 may determine whether the batteries 1610 are in an unbalanced state based on respective state values of the batteries 1610. The processor 1660 may control a balancing circuit of a selected battery (e.g., a battery having a maximum state value) among the batteries 1610 such that the capacitor 1640 are charged when the batteries 1610 are in an unbalanced state. The processor 1660 may determine a target battery to receive power from the capacitor 1640 among the batteries 1610 based on the respective state value of the batteries 1610. The processor 1660 may form a current path including a first switch connected in series to the target battery such that power from the capacitor 1640 may be transmitted to the target battery.

The battery pack 1601 may include a memory (not shown), and a battery model (e.g., an electrochemical model, a deep learning model, etc.) may be stored in the memory of the battery pack 1601. The processor 1660 may estimate an internal short circuit state of each of the batteries 1610 by inputting a voltage value of each of the batteries 1610, a current value (and/or a current value of each of the batteries 1610) of the battery pack 1601, and/or a temperature value of each of the batteries 1610 into the battery model. The processor 1660 may determine whether there is an abnormal battery among the batteries 1610 through the internal short circuit state of each of the batteries 1610. The processor 1660 may estimate a state of health (SOH) (and/or an SOH of the battery pack 1601) of each of the batteries 1610 by inputting the voltage value of each of the batteries 1610, the current value of the battery pack 1601, and/or the temperature value of each of the batteries 1610 into the battery model. The SOH (and/or the SOH of the battery pack 1601) of each of the batteries 1610 refers to a degree to which each of the batteries 1610 (and/or the battery pack 1601) is degraded compared to each of the batteries 1610 (and/or the battery pack 1601) at the time of manufacture.

The electronic device 100 described with reference to FIGS. 1 to 15 may be applied to the battery system 1600 (and/or the battery pack 1601) of FIG. 16.

FIG. 17 is a block diagram illustrating an example of a mobile device according to one or more embodiments.

Referring to FIG. 17, a mobile device (and/or an electronic device) 1700, according to one or more embodiments, may include batteries 1710, balancing circuits 1720, first switches 1730, a capacitor 1740, a third switch 1750, a processor 1760 (e.g., one or more processors), a power management integrated circuit (PMIC) 1770, a memory 1780 (e.g., one or more memories), and a display 1790. Although not shown in FIG. 17, the mobile device 700 may further include a wireless communication circuit capable of performing wireless communication (e.g., fourth-generation (4G) communication, fifth-generation (5G) communication, and/or Wi-Fi communication), a camera, a speaker, and/or the like.

The mobile device 700 may correspond to a smartphone (e.g., a bar-shaped smartphone, a foldable smartphone, etc.), a tablet PC, a laptop, a smartwatch, a smart band, and/or smart glasses.

The respective descriptions of the balancing circuits 420, 421, 422, 423, the first switches 430, 431, 432, 433, the capacitor 440, the third switch 450, and the processor 460 may apply to the balancing circuits 1720, the first switches 1730, the capacitor 1740, the third switch 1750, and the processor 1760.

The memory 1780 may store instructions executable by the processor 1760. For example, the memory 1780 may be or include a non-transitory computer-readable storage medium storing instructions that, when executed by the processors 1760, configure the processor 1760 perform any one, any combination, or all of operations and/or methods of the processors 1760 (e.g., operations and/or methods of the processor 160, the processor 460, and/or the processor 1660 as described herein). The processor 1760 may control the first switches 1730 and the balancing circuits 1720 and may be electrically connected to the PMIC 1770.

The PMIC 1770 may receive power from an adapter by wire and may charge the batteries 1710 based on the received power. According to embodiments, the PMIC 1770 may receive wireless power from a wireless power transmitter through a wireless charging coil and may charge the batteries 1710 based on the received wireless power. The PMIC 1770 may receive power from at least one of the batteries 1710 and may convert the received power into power having a level suitable for a component (e.g., the processor 1760, the display 1790, the memory 1780, etc.) of the mobile device 1700. The PMIC 1770 may supply the converted power to the component of the mobile device 1700.

The processor 1760 may determine whether the batteries 1710 are in an unbalanced state based on respective state values of the batteries 1710. The processor 1760 may control a balancing circuit of a selected battery (e.g., a battery having a maximum state value) among the batteries 1710 such that the capacitor 1740 are charged when the batteries 1710 are in an unbalanced state. The processor 1760 may determine a target battery to receive power from the capacitor 1740 among the batteries 1710 based on the respective state value of the batteries 1710. The processor 1760 may form a current path including a first switch connected in series to the target battery such that power from the capacitor 1740 may be transmitted to the target battery.

The electronic device 100 described with reference to FIGS. 1 to 15 may be applied to the mobile device 1700 of FIG. 17.

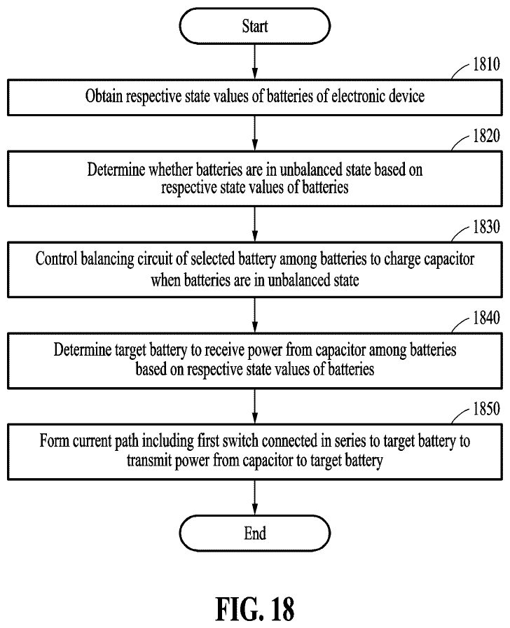

FIG. 18 is a flowchart illustrating an operating method of an electronic device according to one or more embodiments.

Referring to FIG. 18, in operation 1810, the electronic device 100 may obtain respective state values of batteries of the electronic device 100.

In operation 1820, the electronic device 100 (and/or the battery system 1600 or the mobile device 1700) may determine whether the batteries 110 are in an unbalanced state based on the respective state values of the batteries 110.

In operation 1830, the electronic device 100 may control a balancing circuit of a selected battery among the batteries 110 to charge the capacitor 140 when the batteries 110 are in an unbalanced state. For example, the processor 160 may identify a first battery having a maximum state value among the respective state values of the batteries 110 when the batteries 110 are in an unbalanced state. The processor 160 may transmit a PWM signal to a second switch of a balancing circuit of the first battery. The balancing circuit of the first battery may charge the capacitor 140 by using the first battery when the PWM signal is transmitted to the second switch. The balancing circuit of the first battery may induce a current to a second coil of a transformer when a current of the first battery flows into a first coil of the transformer while the PWM signal is transmitted to the second switch and may charge the capacitor 140 through the induced current.

In operation 1840, the electronic device 100 may determine a target battery to receive power from the capacitor 140 among the batteries 110 based on the respective state values of the batteries 110. For example, the processor 160 may determine an average value of the respective state values of the batteries 110 and may determine a battery having a state value less than the average value to be the target battery.

In operation 1850, the electronic device 100 may form a current path including a first switch connected in series to the target battery to transmit power from the capacitor 140 to the target battery. For example, the processor 160 may form the current path by changing a state of the first switch connected in series to another battery (e.g., a battery that is not the target battery among the batteries 110) to a turn-off state and changing a second switch in a balancing circuit of the other battery to a turn-on state.

In one or more embodiments, the electronic device 100 (e.g., the processor 160) may stop transmitting a PWM signal to the second switch of the balancing circuit of the first battery when target power of the capacitor 140 is stored in the capacitor 140 by using the first battery. The electronic device 100 (e.g., the processor 160) may change a state of the third switch 150 connected to the capacitor 140 to a turn-on state such that the capacitor 140 may be electrically connected to the target battery.

According to one or more embodiments, the electronic device 100 (e.g., the processor 160) may determine the target power of the capacitor 140 based on an average value of the respective state values of the batteries 110 and a state value of the first battery. The electronic device 100 (e.g., the processor 160), when determining the target power, may transmit a PWM signal to the second switch of the balancing circuit of the first battery.

According to one or more embodiments, the electronic device 100 (e.g., the processor 160), when the batteries 110 includes an abnormal battery that is suspected to be abnormal, may change a state of a first switch connected in series to the abnormal battery to be turned off and may change a state of a second switch in a balancing circuit of the abnormal battery to be turned on. The electronic device 100 (e.g., the processor 160), in a turn-off state of the first switch connected in series to the abnormal battery and a turn-on state of a second switch in a balancing circuit of the abnormal battery, may cut off an electrical connection between another battery and the abnormal battery and may form an electrical connection between the other battery and the balancing circuit of the abnormal battery. Accordingly, in a charging mode of the electronic device 100, a charging current may bypass the abnormal battery and may flow into the balancing circuit of the abnormal battery, and, in a discharged mode of the electronic device 100, the abnormal battery may not supply power to a load. In the charging mode and discharged mode of the electronic device 100, the abnormal battery may not be in the current path of the electronic device 100, and thus, the abnormal battery may not be charged in the charging mode and the abnormal battery may not supply power to the load in the discharged mode.

The electronic device 100 described with reference to FIGS. 1 to 15 may be applied to the operating method of the electronic device of FIG. 18.

The electronic devices, batteries, balancing circuits, first switches, capacitors, third switches, processors, second switches, transformer, battery systems, battery packs, loads, chargers, mobile devices, PMICs, memories, displays, electronic device 100, batteries 110, balancing circuits 120, first switches 130, capacitor 140, third switch 150, processor 160, balancing circuit 200, second switch 210-1, transformer 210-2, processor 460, batteries 1510, 1520, 1530, 1540, battery system 1600, battery pack 1601, batteries 1610, balancing circuits 1620, first switches 1630, capacitor 1640, third switch 1650, processor 1660, load 1670, charger 1680, mobile device 1700, batteries 1710, balancing circuits 1720, first switches 1730, capacitor 1740, third switch 1750, processor 1760, PMIC 1770, memory 1780, and display 1790 described herein, including descriptions with respect to respect to FIGS. 1-18, are implemented by or representative of hardware components. As described above, or in addition to the descriptions above, examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit (ALU), a digital signal processor (DSP), a microcomputer, a programmable logic controller, a field-programmable gate array (FPGA), a programmable logic array (PLU), a microprocessor, or any other device or combination of devices that is configured to respond to and execute instructions (e.g., code or coding) in a defined manner to achieve a desired result. In one example, a processor or computer includes, or is connected to, one or more memories storing the instructions or software that are executed by the processor or computer. Hardware components implemented by a processor or computer may execute the instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both, and thus while some references may be made to a singular processor or computer, such references also are intended to refer to multiple processors or computers. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. As described above, or in addition to the descriptions above, example hardware components may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing. Thus, references to a processor herein mean processing circuitry (e.g., circuitry that includes one or more processing element(s) circuits). One or more processors comprising processing circuitry also refers to each processor comprising processing circuitry, as well as some or all of the one or more processors comprising the same processing circuitry. In addition, processors(s) and controller(s), as a non-limiting example, do not mean human processing or human control, but rather, refer to hardware components as described herein, as non-limiting examples.

The methods illustrated in, and discussed with respect to, FIGS. 1-18 that perform the operations described in this application are performed by computing hardware, for example, by one or more processors or computers, implemented as described above implementing the instructions (e.g., computer or processor/processing device readable instructions) or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations. References to a processor, or one or more processors, as a non-limiting example, configured to perform two or more operations refers to a processor or two or more processors being configured to collectively perform all of the two or more operations, as well as a configuration with the two or more processors respectively performing any corresponding one of the two or more operations (e.g., with a respective one or more processors being configured to perform each of the two or more operations, or any respective combination of one or more processors being configured to perform any respective combination of the two or more operations). Likewise, a reference to a processor-implemented method is a reference to a method that is performed by one or more processors or other processing or computing hardware of a device or system.

The instructions or software to control computing hardware, for example, one or more processors or computers, to implement the hardware components and perform the methods as described above may be written as computer programs, code segments, or other executable instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media, and thus, not a signal per se. Thus, references herein to storage media mean storage media hardware, and does not mean transitory media, nor a signal per se. As described above, or in addition to the descriptions above, examples of a non-transitory computer-readable storage medium include one or more of any of read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as a multimedia card or a micro card (for example, secure digital (SD) or extreme digital (XD)), magnetic tapes, floppy disks, magneto-optical data storage devices, optical data storage devices, hard disks, solid-state disks, and/or any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. An electronic device comprising:
a plurality of batteries;
first switches, wherein the first switches are connected in series respectively to the plurality of batteries;
balancing circuits of the plurality of batteries;
a capacitor that is connected to each of the balancing circuits and is charged by one or more of the plurality of batteries; and
one or more processors configured to:
determine whether the plurality of batteries is in an unbalanced state based on respective state values of the plurality of batteries;
control a balancing circuit of a selected battery such that the capacitor is charged by the selected battery among the plurality of batteries in response to the plurality of batteries being in the unbalanced state;
determine a target battery to receive power from the capacitor among the plurality of batteries based on the respective state values of the plurality of batteries; and
form a current path comprising a first switch connected in series to the target battery such that the power from the capacitor is transmitted to the target battery.

2. The electronic device of claim 1, wherein the one or more processors are configured to form the current path by changing a state of the first switch connected in series to another battery to a turn-off state and a second switch in a balancing circuit of the other battery to a turn-on state.

3. The electronic device of claim 1, wherein
the one or more processors are configured to:
identify a first battery having a maximum state value among the respective state values of the plurality of batteries in response to the plurality of batteries being in the unbalanced state; and
transmit a pulse width modulation (PWM) signal to a second switch of a balancing circuit of the first battery, and
the balancing circuit of the first battery is configured to charge the capacitor by using the first battery in response to the PWM signal being transmitted to the second switch.

4. The electronic device of claim 3, wherein the balancing circuit of the first battery comprises a transformer comprising a first coil and a second coil, is configured to induce a current to the second coil in response to a current of the first battery flowing into the first coil while the PWM signal is transmitted to the second switch, and is configured to charge the capacitor through the induced current.

5. The electronic device of claim 3, wherein the one or more processors are configured to:
stop transmitting the PWM signal to the second switch in response to a target power of the capacitor being stored in the capacitor by using the first battery; and
change a third switch connected to the capacitor to a turn-on state such that the capacitor is electrically connected to the target battery.

6. The electronic device of claim 5, wherein the one or more processors are configured to:
determine the target power based on an average value of the respective state values of the plurality of batteries and a state value of the first battery; and
in response to determining the target power, transmit the PWM signal to the second switch.

7. The electronic device of claim 1, wherein the one or more processors are configured to:
determine the average value of the respective state values of the plurality of batteries; and
determine a battery having a state value less than the average value to be the target battery.

8. The electronic device of claim 1, further comprising:
a third switch forming an electrical connection between the target battery and the capacitor,
wherein the third switch is turned off before the target power is stored in the capacitor and is turned on in response to the target power being stored in the capacitor.

9. The electronic device of claim 1, wherein
the one or more processors are configured to, in response to the plurality of batteries comprising an abnormal battery that is suspected to be abnormal, change a state of a first switch connected in series to the abnormal battery to a turn-off state and a state of a second switch in a balancing circuit of the abnormal battery to a turn-on state, and
in the turn-off state of the first switch connected in series to the abnormal battery and the turn-on state of the second switch in the balancing circuit of the abnormal battery, an electrical connection between the abnormal battery and another battery is stopped and an electrical connection between the balancing circuit of the abnormal battery and the other battery is formed.

10. The electronic device of claim 9, wherein
in a charging mode of the electronic device, a charging current bypasses the abnormal battery and flows into the balancing circuit of the abnormal battery, and
in a discharged mode of the electronic device, the abnormal battery does not supply power to a load.

11. The electronic device of claim 1, wherein the respective state values of the plurality of batteries comprise either one or both of respective voltage values and respective state of charge (SOC) values of the plurality of batteries.

12. An electronic device comprising:
a plurality of batteries;
first switches, wherein the first switches are connected in series respectively to the plurality of batteries;
balancing circuits of the plurality of batteries, wherein each of the balancing circuits comprises a second switch;
a capacitor that is connected to each of the balancing circuits and is charged by one or more of the plurality of batteries;
a third switch connected to the capacitor; and
one or more processors configured to:
determine a target battery to receive power from the capacitor among the plurality of batteries based on respective state values of the plurality of batteries in response to the plurality of batteries being in an unbalanced state; and
control a first switch connected in series to the target battery, a second switch of a balancing circuit of another battery that is not the target battery, and the third switch such that the first switch connected in series to the target battery, the second switch of the balancing circuit of the other battery, and the third switch are turned on,
wherein, based on a turn-on state of the first switch connected in series to the target battery, the second switch of the balancing circuit of the other battery, and the third switch, power from the capacitor is transmitted to the target battery.

13. A processor-implemented method comprising:
determining whether a plurality of batteries is in an unbalanced state based on respective state values of the plurality of batteries;
charging a capacitor by controlling a balancing circuit of a selected battery in response to the plurality of batteries being in the unbalanced state;
determining a target battery to receive power from the capacitor among the plurality of batteries, based on the respective state values of the plurality of batteries; and
forming a current path comprising a first switch connected in series to the target battery such that the power from the capacitor is transmitted to the target battery.

14. The method of claim 13, wherein the forming of the current path comprises changing a state of the first switch connected in series to another battery to a turn-off state and a second switch in a balancing circuit of the other battery to a turn-on state.

15. The method of claim 13, wherein the charging of the capacitor comprises:
identifying a first battery having a maximum state value among the respective state values of the plurality of batteries in response to the plurality of batteries being in the unbalanced state;
transmitting a pulse width modulation (PWM) signal to a second switch of a balancing circuit of the first battery; and
charging the capacitor by using the first battery in response to the PWM signal being transmitted to the second switch.

16. The method of claim 15, wherein the balancing circuit of the first battery comprises a transformer comprising a first coil and a second coil, is configured to induce a current to the second coil in response to a current of the first battery flowing into the first coil while the PWM signal is transmitted to the second switch, and is configured to charge the capacitor through the induced current.

17. The method of claim 15, further comprising:
stopping transmitting the PWM signal to the second switch in response to a target power of the capacitor being stored in the capacitor by using the first battery; and
changing a third switch connected to the capacitor to a turn-on state such that the capacitor is electrically connected to the target battery.

18. The method of claim 17, further comprising determining the target power based on an average value of the respective state values of the plurality of batteries and a state value of the first battery.

19. The method of claim 13, wherein the determining of the target battery comprises determining an average value of the respective state values of the plurality of batteries and determining a battery having a state value less than the average value to be the target battery.

20. The method of claim 13, further comprising:
in response to the plurality of batteries comprising an abnormal battery that is suspected to be abnormal, changing a state of a first switch connected in series to the abnormal battery to a turn-off state and a state of a second switch in a balancing circuit of the abnormal battery to a turn-on state,
wherein, in the turn-off state of the first switch connected in series to the abnormal battery and the turn-on state of the second switch in the balancing circuit of the abnormal battery, an electrical connection between the abnormal battery and another battery is stopped and an electrical connection between the balancing circuit of the abnormal battery and the other battery is formed.
